(19) United States
(12) Patent Application Publication
(10) Pub. No.: US 2009/0304309 A1
(43) Pub. Date: Dec. 10, 2009

(54) CLOSURE FOR RESEALABLE PACKAGE

(75) Inventors: Jason Hayes, Heathmont (AU); Sebastian Garst, Camberwell (AU); Martin Telgarsky, Croydon South (AU); Karlo Jolic, West Footscray (AU); Steve Stoddart, Yetholme (AU); Edmond Lascaris, Bundoora (AU)

Correspondence Address: FULBRIGHT & JAWORSKI, LLP, 1301 MCKINNEY, SUITE 5100, HOUSTON, TX, 77010-3095, US

(73) Assignee: MARS INCORPORATED, McLean, VA (US)

(21) Appl. No.: 11/916,843

(22) PCT Filed: Jun. 13, 2006
(86) PCT No.: PCT/AU06/00815

§ 371 Date: Jun. 10, 2008

(30) Foreign Application Priority Data
Jun. 10, 2005 (AU) 2005903030

(51) Int. Cl. B65D 33/16; B31B 1/90; B31B 1/00

(52) U.S. Cl. 383/63; 493/214; 493/267

(57) ABSTRACT

A closure mechanism for use with bag- or sachet-like packaging which is substantially formed by opposing sheets of polymeric material; wherein said closure mechanism includes first and second sets of opposing substantially parallel ridges, said ridges defining complementary grooves therebetween that are adapted to receive said opposing ridges in a form-locking engagement; wherein the surface of said ridges and grooves feature a plurality of ribs extending traverse and from said surfaces such that, when said first form-locking engagement is made, the ribs extending from said ridges tend to interfere with the ribs extending from said grooves thereby to impede unintentional opening of said closure.

### CROSS-REFERENCE TO RELATED APPLICATIONS

This application is a national stage application of PCT/AU2006/000815 filed Jun. 13, 2006 claiming priority to AU 2005903030 filed Jun. 10, 2005.

### TECHNICAL FIELD

The invention relates to the field of closures for food packages. In particular, the invention relates to an improved closure for flexible packages of the type that allows reclosure of said package via a form-locking arrangement.

### BACKGROUND OF THE INVENTION

There is an increasing demand for improved convenience in food packaging formats. In particular, in relation to free-flowing ‘dry’ food products, there is a demand for bags or sachets which can be effectively reclosed after opening. In this document, it will be understood by those skilled in the art that the term ‘reclose’ or ‘reclosure’ refers to closure of an unsealed package, such that the contents will not fall out if the packet is knocked over in normal use, or is stored on its side, and which substantially impedes the ingress of air which may spoil the products held within. These terms do not refer to an air- or water-tight seal.

One approach to providing a resealable closure for a sachet, which is well known in the art, is the form-locking closure commercially known as ‘snap-lock’. These and similar devices involve the formation of a male/female ridge and groove sealing mechanism across the opening of a sachet. The inner surface of the sachet, near the web material edge that defines the opening, is provided on one side with a longitudinal ridge, often with a bulbous profile, which extends across the width of the sachet opening, and is provided on the other side with at least two similar longitudinal channel-defining ridges which are adapted to receive between them, in a form-locking manner, the first said ridge. By ‘form-locking’ is meant a male/female engagement, wherein the male portion in inserted into a female receptor and is resiliently held there due to envelopment of said male portion by said receptor.

Typically, these ridges are formed from a resilient plastic material on a band or strip, separately from the sachet web material, and are fixed to the sachet material by bonding or other techniques. Sealing engagement of the closure is effected by forcing the first said ridge in between the second said ridges. In order for this kind of resealable closure to be effective it is necessary for quite precise dimensional control to be exercised during the manufacture of the ridges to ensure that the single ridge will in fact be held in an effective sealing engagement between the other two ridges. This also requires that the materials from which the ridges are constructed to have sufficient stiffness in order to maintain the engagement, and at the same time have sufficient resilience to maintain the form lock.

Because of these constraints on the design, there are a number of disadvantages which are associated with this closure type. For example, the requirement for the closure elements to be formed separately from the sachet material adds to the overall complexity, and therefore the cost of manufacture, of reclosable sachets or bags. The requirement to attach these components to the sachet material may also limit the types of sachet materials to which the ‘snap-lock’ closure may be effectively applied.

Another disadvantage of these kind of systems is that, due to the necessary stiffness of the closure ridges, and the precise alignment into which they must be placed for sealing inter-engagement, it can sometimes be difficult to manually effect reclosure of the sachet or bag. Equally, sometimes the overall stiffness of the closure, once made, can exceed the strength of the sachet material itself. This can result in the tearing of the sachet material when the user attempts to re-open the sachet.

It is one object of the present invention to provide a closure mechanism for use with bag- or sachet-like packaging that substantially ameliorates one or more of the deficiencies of the prior art. A further object resides in providing a bag or sachet package for low-moisture food products which features a reclosure mechanism that provides sufficient rigidity to maintain the closed state of the packaging whilst avoiding the deficiencies of the prior art. A yet further object of the invention is to provide a method for constructing such a closure mechanism and package.

### BRIEF SUMMARY OF THE INVENTION

According to one aspect of the invention, there is provided a closure mechanism for use with bag- or sachet-like packaging which is substantially formed by opposing sheets of polymeric material; wherein said closure mechanism includes first and second sets of opposing substantially parallel ridges, said ridges defining complementary grooves therebetween that are adapted to receive said opposing ridges in a form-locking engagement; wherein the surface of said ridges and grooves feature a plurality of ribs extending traverse and from said surfaces such that, when said first form-locking engagement is made, the ribs extending from said ridges tend to interfere with the ribs extending from said grooves thereby to impede unintentional opening of said closure.

An advantage of the invention as described above is that the ribs provide a means by which an enhanced seal can be made between the sheets of the bag or sachet. Therefore, the ridges do not have to be formed in as precise a manner as in the prior art, and also do not have to be made as stiff as those in the prior art. The interference which occurs between the ribs on adjacent opposing surfaces assists in holding the closure mechanism in a closed position, as well as creating a more tortuous pathway through which the atmosphere external to the closure must pass in order to reach the products contained inside the bag or sachet.

A further advantage of the invention is that the ridges and ribs may be formed integral with the polymeric material from which the bag or sachet is mainly composed, simplifying the structure of the closure, as compared with the prior art. This is anticipated to reduce the cost of providing the closure.

The presence of the ribs has a further beneficial effect in that they create an audible noise as they slide across one another as the closure is being effected. This is typically a distinctive ‘snap’ or “zip” sound as the ridges are forced into the grooves. This is desirable as it gives a clear overall indication of when the closure has been effected.

While the use of ribs of the kind featured in the present invention, sometimes known as ‘microprotrusions’, are known in some arts relating to fasteners and the like, the present invention represents a new and inventive adaptation of this technology to solve a problem for which the known uses of microprotrusions have not proved suitable. For example, one use of microprotrusions is disclosed in U.S. Pat. No. 5,657,516 and U.S. Pat. No. 6,223,401 by the Minnesota Mining and Manufacturing Company (‘the 3M patents’). However, the structures described in the 3M patents would not be suitable for solving at least some of the problems addressed by the present invention.

For example, the 3M patents do not disclose the use or ability of such microprotrusions to enhance the sealing ability of the kind of form-locking structures to which the present invention is directed. Instead, document no. 5,657,516 discloses fasteners for items of clothing which rely wholly on the interaction between the disclosed microprotrusions to effect the fastening engagement. In addition, the fastening structures disclosed in the 3M patents would be extremely difficult to form from the relatively thin polymeric materials which are typical of the sachets towards which the present invention is directed.

Preferably, said ridges and ribs are formed unitary and integral with said first and second sheets. This greatly enhances the simplicity of the closure, and thereby reduces the cost of applying the closure to the package.

In a preferred embodiment, said ribs extend from the surface of said ridges less than 0.4 mm, and run substantially parallel with said ridges. Preferably, said ribs are spaced apart by between 0.04 mm and 0.7 mm. Advantageously, said ribs are formed by an embossing process.

In a second preferred embodiment, where thinner materials are used to form the walls of the bag or sachet, said ribs extend from the surface of the said ridges less than 0.16 mm, and run substantially parallel with said rides. Preferably, said ribs are 0.08 mm wide and created on a pitch of 0.2 mm.

Preferably, said ridges are formed as a loop in said polymeric sheet. This enhances the ability of the ridges to be formed integral with the relatively thin polymeric materials from which such bags or sachets are typically constructed.

According to a second embodiment, the invention provides a bag- or sachet-like package which is substantially formed by opposing sheets of polymeric material, said package being provided with a closure mechanism; wherein said closure mechanism includes first and second sets of opposing substantially parallel ridges, said ridges defining complementary grooves therebetween that are adapted to receive said opposing ridges in a form-locking engagement; wherein the surface of said ridges and grooves feature a plurality of ribs extending traverse and from said surfaces such that, when said first form-locking engagement is made, the ribs extending from said ridges tend to interfere with the ribs extending from said grooves thereby to impede unintentional opening of said closure.

According to a third embodiment, the invention provides a method for manufacturing a closure mechanism for a bag or sachet as defined above, said method including the steps of:

embossing the opposing surfaces of said polymeric sheets, in at least an area adjacent an opening of said bag or sachet, in order to form said ribs;

then shaping said polymeric sheets, in the area so embossed, to form said ridges in said sheets;

wherein said ridges are formed substantially parallel with said ribs, and wherein other steps may be performed within said method.

The above process steps may be carried out at different times or stages of the manufacture of the sachet. For example, the embossing stage may be performed during the manufacture of polymeric sheets intended for use in a form-fill-seal operation, and then stored until required. Then, during the sealing operation, the ridge shaping operation may be carried out to complete the method.

Now will be described, by way of specific, non-limiting examples, preferred embodiments of the invention.

### BRIEF DESCRIPTION OF THE DRAWINGS

FIG. 1 is a schematic partial cross sectional view of a sachet which features a closure mechanism according to the invention, showing the closure mechanism in an open position.

FIG. 2 is a schematic partial cross sectional view of a sachet which features a closure mechanism according to the invention, showing the closure mechanism in a partly closed position.

FIG. 3 is a schematic partial cross sectional view of a sachet which features a closure mechanism according to the invention, showing the closure mechanism in a closed position.

FIG. 4 is a schematic partial cross sectional view of a sachet which features an alternative closure mechanism according to the invention, showing the closure mechanism in a closed position.

FIG. 5 is a diagram of a male embossing mould suitable for forming ribs in accordance with the invention.

FIG. 6 is a diagram of a female embossing tool, reciprocal to that of FIG. 5, suitable for forming ribs in accordance with the invention.

FIG. 7 is a micrograph of a laminated PET/PE film embossed with ribs in accordance with the invention, wherein said ribs are formed in the PE layer.

FIG. 8 is a diagram of a PMMA mould suitable for forming ridges in a PE/PET film, in accordance with the invention.

FIG. 9 is a diagram of sections of PE/PET film to which the inventive closure mechanism has been applied, shown in an interlocking engagement.

### DETAILED DESCRIPTION OF THE INVENTION

The invention provides an improved mechanism for effecting a releasable closure of a bag or sachet. There are a number of physical formats in which the invention may be embodied. Now will be described two particularly preferred such embodiments.

### Example 1

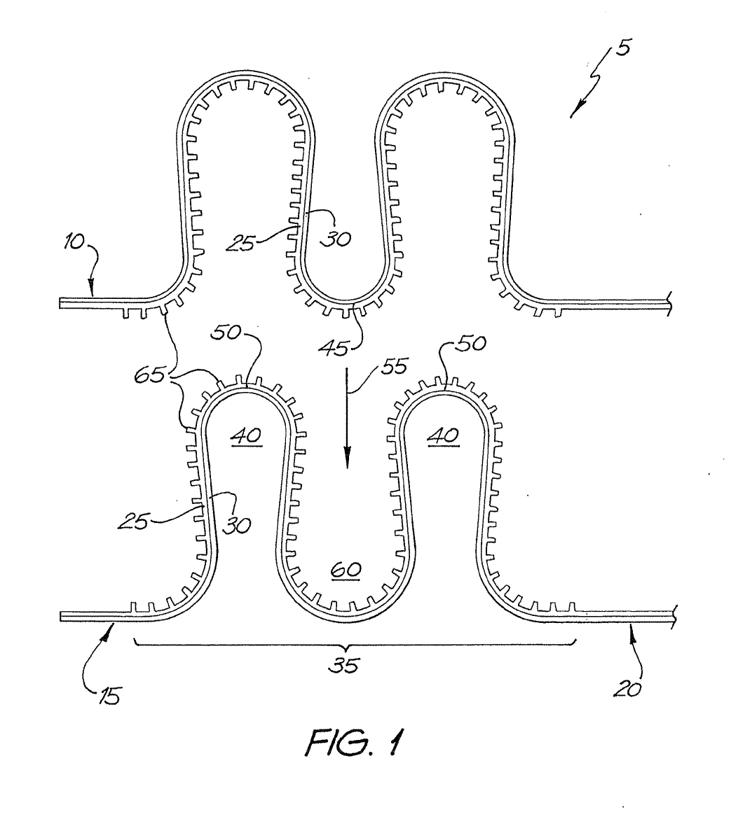

Turning first to FIG. 1 there is shown a schematic cross sectional view of the open end of a sachet 5 according to the invention. The sachet 5 features first 10 and second 15 overlapping polymeric sheets. In this case, a preferred composition of the sheets 20 is a multi-layer construction of polyethylene (PE) and polyethylene terephthalate (PET), wherein the PE layer 25 comprises the ‘inner’ or ‘facing’ layers of said sheets forming the sachet, and the PET layer 30 comprises the outer surface of said sachet 5.

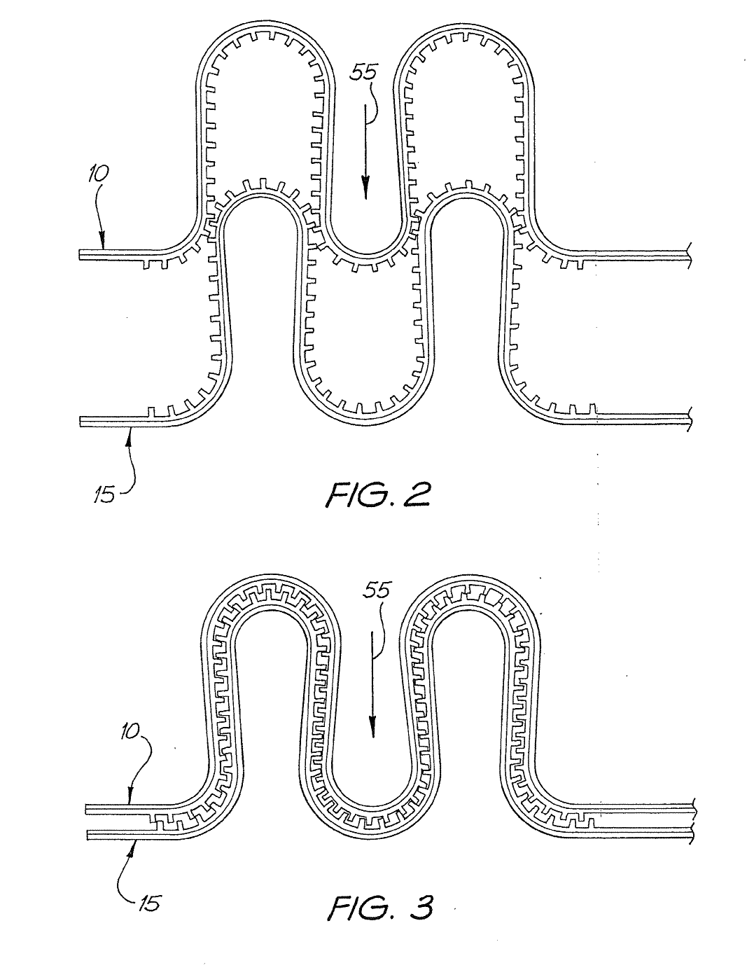

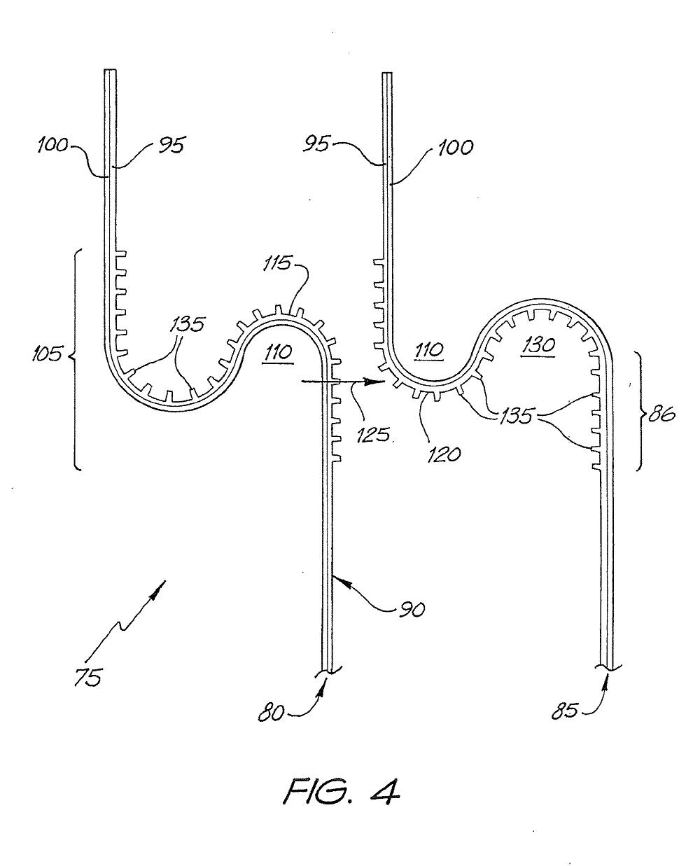

The sachet features a closure area 35, in which the polymeric sheet 20 has been formed into complementary interlocking ridges 40, as seen in profile in FIG. 1. The ridge 45 in the upper sheet 10 has been formed to be engagingly received between the two ridges 50 formed in the lower sheet 15 as drawn. When the upper sheet 10 is forced in the direction of the arrow 55, the single upper ridge 45 forces its way between the two resilient lower ridges 50, slightly displacing them from their original position as it passes through to be received in the ‘valley’ 60 formed between two said ridges. This operation is illustrated in different stages on FIGS. 2 and 3.

The surfaces of the PE layer 25 in the sachet 5, at least in the area adjacent the above described ridges (45, 50), are covered by a series of rib-like secondary protrusions, or ‘micro protrusions’ 65. These microprotrusions 65 are ribs, each protruding approximately 0.3 mm from the surface of the PE layer 25, and which run substantially parallel to the direction of the ridges (45, 50) from which they protrude. Such a closure mechanism is shown in interlocking engagement in FIG. 9.

It will be appreciated by those skilled in the art that, in order for the interlocking procedure of the ridges (45, 50), as described above, to be carried out manually, it is necessary for the ridges (45, 50) to be reasonably flexible. Therefore the force required to both open and close the sachet 5 should be reasonably low. However, if this force is too low, the seal will not be maintained during normal conditions of use.

It is an advantage of the present invention that the presence of the microprotrusions 65, and the tendency of the microprotrusions 65 on the first sheet 10 to interfere with the microprotrusions 65 to which they come in contact on the second sheet 15, and vice versa, acts to increase the overall coefficient of friction between the surfaces of the ridges (45, 50). This in turn allows a more secure interlocking engagement to be formed between the two sheets (10, 15), without greatly increasing the force required to open or close the seal. The position of the microprotrusions 65 when the sachet is closed, also tends to increase the path length for any gases travelling either into or out of the sachet 5, which further contributes to the ability of the product in the sachet 5 to be protected from, for example, humid air.

In one preferred embodiment the PE/PET sheets (10, 15) are approximately 0.125 mm in thickness and the microprotrusions 65 protrude approximately 0.3 mm from the ridges (45, 50). The microprotrusions 65 are 0.15 mm wide, and are spaced apart at approximately a 0.5 mm pitch. The ridges (45, 50) protrude approximately 4.0 mm from the polymeric sheets (10, 15) and have a pitch of approximately 4.0 mm. At their widest point, the ridges (45, 50) have a width of approximately 2.0 mm, and approximately 1.0 mm at their narrowest point.

It will be appreciated by those skilled in the art that, while the exemplary embodiment described above feature a closure mechanism having a single upper primary ridge being received by one or two lower ridges, the precise number of ridges on the upper and lower sheets is immaterial to the invention: any number of ridges may be provided on the upper and lower sheets provided they each have the structure substantially described above thereby to be adapted to interlock in the manner provided by the invention.

### Example 2

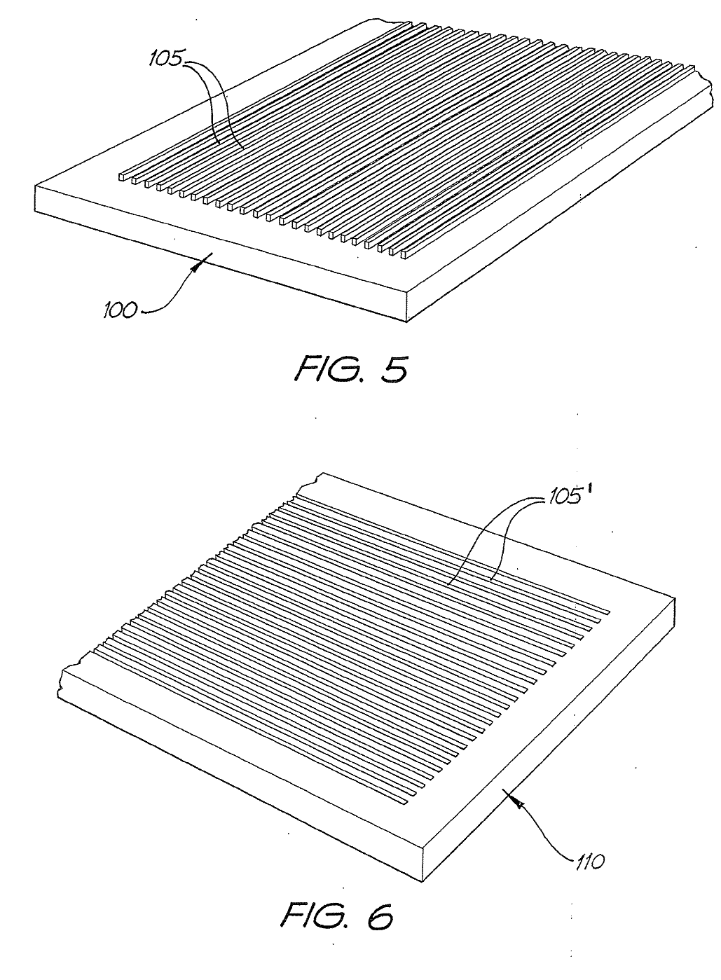

Turning to FIG. 4 there is shown a schematic cross sectional view of the open end of a sachet 75 according to the invention. The sachet 75 features first 80 and second 85 overlapping polymeric sheets. In this case, a preferred composition of the sheets 90 is a multi-layer construction of polyethylene (PE) and polyethylene terephthalate (PET), wherein the PE layer 95 comprises the ‘inner’ or ‘facing’ layers of said sheets forming the sachet, and the PET layer 100 comprises the outer surface of said sachet 75.

The sachet features a closure area 105, in which the polymeric sheet 90 has been formed into complementary interlocking ridges 110, as seen in profile in FIG. 4. The ridge 115 in the leftmost sheet 80 has been formed to be engagingly received between the ridge 120 formed in the rightmost sheet 85 and the lower portion 86 of the rightmost sheet 85, as drawn. When the leftmost sheet 80 is forced in the direction of the arrow 125, the single upper ridge 115 forces its way beneath the resilient ridge 120, slightly displacing it from its original position as it passes through to be received in the inverted ‘valley’ 130 formed between ridges 120 and sheet 86.

The surfaces of the PE layer 95 in the sachet 75, at least in the area adjacent the above described ridges (115, 120), are covered by a series of rib-like secondary protrusions, or ‘microprotrusions’ 135. These microprotrusions 135 are ribs, each protruding approximately 0.16 mm from the surface of the PE layer 95, and which run substantially parallel to the direction of the ridges (115, 120) from which they protrude.

It will be appreciated by those skilled in the art that, in order for the interlocking procedure of the ridges (115, 120), as described above, to be carried out manually, it is necessary for the ridges (115, 120) to be reasonably flexible. Therefore the force required to both open and close the sachet 75 should be reasonably low. However, if this force is too low, the seal will not be maintained during normal conditions of use.

It is an advantage of the present invention that the presence of the microprotrusions 135, and the tendency of the microprotrusions 135 on the first sheet 80 to interfere with the microprotrusions 135 to which they come in contact on the second sheet 15, and vice versa, acts to increase the overall coefficient of friction between the surfaces of the ridges (115, 120). This in turn allows a more secure interlocking engagement to be formed between the two sheets (80, 85), without greatly increasing the force required to open or close the seal. The position of the microprotrusions 135 when the sachet is closed, also tends to increase the path length for any gases travelling either into or out of the sachet 75, which further contributes to the ability of the product in the sachet 75 to be protected from, for example, humid air.

In this embodiment, it is preferred that the PE/PET sheets (80, 85) are approximately 0.084 mm in thickness and the microprotrusions 135 protrude approximately 0.16 mm from the ridges (115, 120). The microprotrusions 135 are 0.08 mm wide, and are spaced apart at approximately a 0.2 mm pitch. The ridges (115, 120) protrude approximately 5.0 mm from the polymeric sheets (90, 95). This arrangement is referred to as the ‘S-Bend’ due to the cross sectional profile.

It is anticipated that thinner flexible PE/PET laminates may be suitable for carrying the rib and ridge structures described above.

Now will be described a method of manufacture suitable for producing the structures described above, with particular reference the structure of example 1. However, the techniques described below can be readily adapted to provide the particular shape described in example 2.

Re-closeable interlocking structures described above are fabricated by firstly applying an embossing process to create the microprotrusions on the inner surface of the sachet material, and secondly applying a forming process to create the interlocking ridges that can repeatedly be interlocked and disengaged with one another, the microprotrusions providing a texture which enhances this engagement.

A frequency-tripled Nd:YAG laser, operating at a wavelength of 355 nm, was used to fabricate polymer (polycarbonate or polyimide) master moulds. The use of such a pulsed, ultra-violet laser enables the fabrication of high aspect ratio structures in polymeric materials, where the width of a machined feature can be down to around 40 μm in width and up to around 500 μm in depth. Structures of these dimensions are difficult to produce economically and over suitable areas by other means.

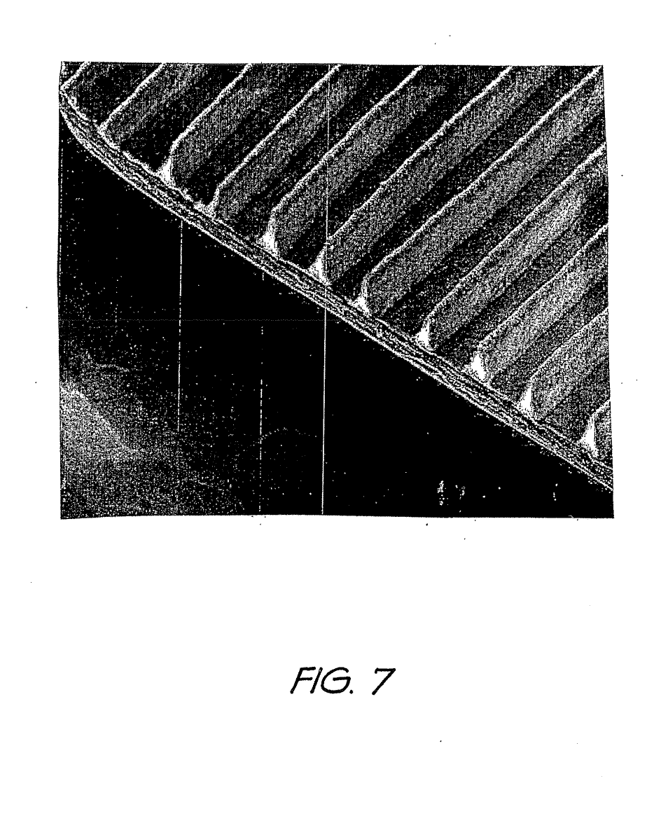

To produce the structure of example 1, the moulds feature parallel micro-channels approximately 160 μm deep, 100 mm long, 0.08 mm wide and having a pitch of 0.2 mm, with patterned areas covering up to 200 mm. The master moulds were electroformed to generate male copies; the male copies in turn were electroformed to form female tooling for both reciprocal and reel-to-reel embossing. FIG. 5 shows a male copy 100 which is designed to complement the female tool shown in FIG. 6, having parallel micro protrusions 105 of width of 0.08 mm, and with a pitch of 0.2 mm.

The complementary female tooling, depicted in FIG. 6, having parallel micro-channels 105′ was used to emboss PE/PET film (as described above and which as used, for example, in the packaging of SCHMACKOS® pet treats, as marketed by Masterfoods Australia and New Zealand, of Kelly St, Wodonga, Victoria, Australia), using a conventional embossing system.

During the embossing process, the PE side of the supplied film was placed in contact with the tooling. The embossing process introduces the above described ribs onto the surface of the PE/PET film, by allowing the molten PE to flow into the micro channels within the tool. Embossing was performed for 5 minutes at 125□ C. and 13 MPa, followed by 5 minutes of cooling under pressure. FIG. 7 shows typical results of the embossing process—parallel micro-protrusions formed in the film are evident, which correspond to the above described secondary protrusions.

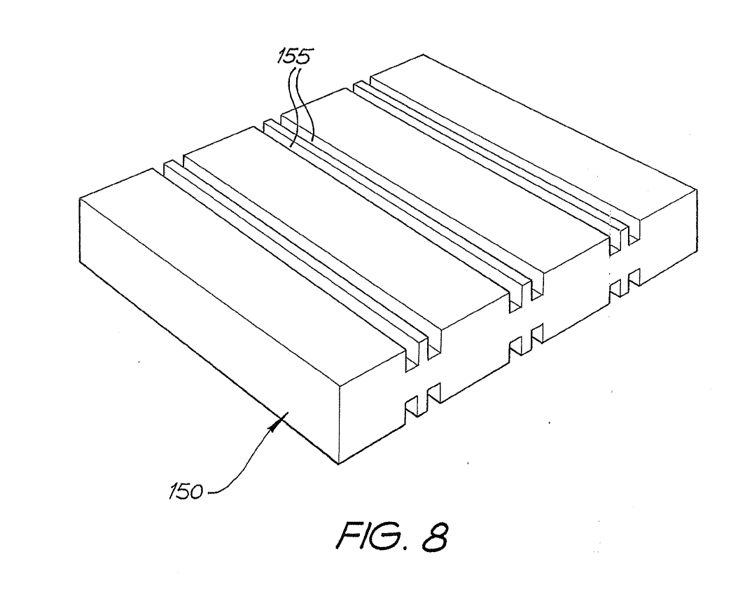

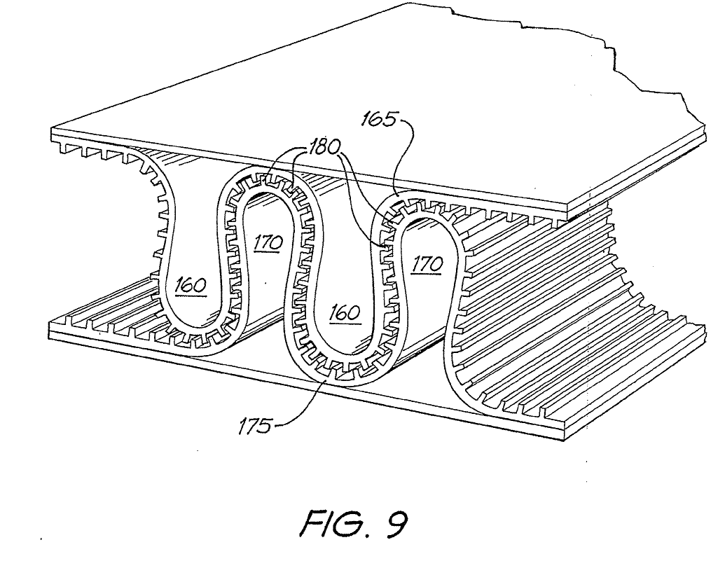

For the structure described in example 1, a CNC milling tool may be used to fabricate a PMMA mould to assist in forming the textured film into macro-channels that can be interlocked, corresponding to the primary protrusions described above. FIG. 8 depicts a suitable PMMA mould 150. This mould 150 has of pairs of channels 155, 2.5 mm wide, 4 mm deep and having 4 mm pitch.

Vacuum-assisted moulding may be used to draw the embossed film into the mould channels. Where this operation is carried out at an elevated temperature, the film will retain the illustrated looped shape upon release from the mould, without requirement for a supporting substrate. A bonding process, such as adhesive, solvent, thermal or ultrasonic bonding, may be used to fuse the bottom edges of the ridges together, to maintain said ridges in place. Thermal bonding processes could include welding, thermal-diffusion, microwave, induction, and conduction bonding processes. Adhesives may be thermally or optically cured (i.e. using light of a suitable wavelength). Solvents may be added to the bonding region so that packaging material is dissolved into a liquid form, where polymer chains from the two surfaces flow and entangle before the solvent evaporates, locking the polymer chains into their new location.

FIG. 9 shows a pair of completed prototype macro reclose structures, attached to a support substrate, effectively interlocked. It can be observed that the macroprotrusion ridges 160 of the upper structure 165 are received in a loose interlocking arrangement between or beside the macroprotrusion ridges 170 of the lower structure 175. The microprotrusion ribs 180 on both sets of ridges (160, 170) then interfere with one another, thereby holding the structures together.

For a sachet made from PE/PET film as described above, fitted with an aligned set of interlockable reclose structures, as per FIG. 4 (i.e. ‘the S-Bend’) and described in example 2, the two opposing sheets of the flexible package may be textured by using a reciprocal hot-embossing process to create the ribs, and then folded to form the characteristic ‘S-bend’ shape before being pressed together. This brings the outer surfaces of the bag into intimate contact where the two mating points (one on each or the two opposing sheets) can be bonded by addition of an adhesive. The ‘S-Bend’ configuration is thus created and holds its form throughout repeated open-and-close operations.

Hot embossing of the ribs 0.16 mm high and 0.08 mm wide may be performed over an area of 175 mm by 12 mm at a temperature 120° C. and a pressure of 0.36 MPa at a duration of 10 s, before separating the mould tool from the polymer laminate without reducing the temperature.

In particular, it is preferred that a reciprocating mechanism be employed to perform the embossing operation. This kind of mechanism has a number of operational advantages. These include: being more able to operate successfully in a wide range of different packaging sizes and formats, as the whole embossing tool does not need to be changed, only the reciprocation rate; and providing more consistent replication of the micro structures.

Reel-to-reel embossing, of the kind well known in the art, may also be used to produce the above described microprotrusions.

The embodiments described above represent prototype version of the product and process according to the invention. It is anticipated that some ancillary details of a fully commissioned production facility for manufacturing the closure system according to the invention will differ in non-essential details from those disclosed above. The essential features of the process and the closure system itself are not anticipated to be different

It will be appreciated by those skilled in the art that the above described package, serving mechanism and method of manufacture represent merely two ways in which the invention can be put into effect. Other embodiments may be conceived of, which while structurally different in some way, would nevertheless fall within the spirit and scope of the invention. For example, it may be that the embossing process may be carried out at a different stage from the forming process, or even in a different facility. The embossed sheets may be supplied to the packing line for the food product, and the forming operation performed as a part of the filling and sealing operation for the package.

1. A reclose mechanism for use with bag- or sachet-like flexible packaging which is substantially formed by opposing sheets of polymeric material, comprising:
a reclose mechanism that includes first and second sets of opposing substantially parallel ridges, formed in opposing surfaces of first and second sheets of polymeric material, said ridges defining complementary grooves therebetween that are adapted to receive said opposing ridges in a form-locking engagement;
wherein the surface of said ridges and grooves feature a plurality of ribs extending traverse and from said surfaces such that, when said first form-locking engagement is made, the ribs extending from said ridges tend to interfere with the ribs extending from said grooves thereby to impede unintentional opening of said reclose mechanism.

2. The reclose mechanism of claim 1, wherein said ridges and ribs are formed unitary and integral with said first and second sheets.

3. The reclose mechanism of claim 1, wherein said ridges are formed as an open loop in said polymeric sheets.

4. The reclose mechanism of claim 1, wherein said ridges are formed as complementary ‘S-shaped’ folds in said polymeric sheets.

5. The reclose mechanism of claim 1, wherein said ribs extend less than 0.4 mm from the surface of said ridges.

6. The reclose mechanism of claim 4, wherein said ribs run substantially parallel with said ridges.

7. The reclose mechanism of claim 5, wherein said ribs are spaced apart by between 0.03 mm and 0.7 mm.

8. The reclose mechanism of claim 6, wherein said ribs are spaced apart on a pitch of 0.1 mm.

9. The reclose mechanism of claim 1, wherein said ribs are formed by an embossing process.

10. The reclose mechanism of claim 1, wherein said ridges are formed by a moulding, folding, or pressing process.

11. A bag- or sachet-like package which is substantially formed by opposing sheets of flexible polymeric material, comprising:
a package provided with a reclose mechanism; said reclose mechanism including first and second sets of opposing substantially parallel ridges, formed in opposing surfaces of first and second sheets of polymeric material, said ridges defining complementary grooves therebetween that are adapted to receive said opposing ridges in a form-locking engagement;
wherein the surface of said ridges and grooves feature a plurality of ribs extending traverse and from said surfaces such that, when said first form-locking engagement is made, the ribs extending from said ridges tend to interfere with the ribs extending from said grooves thereby to impede unintentional opening of said reclose mechanism.

12. The package of claim 11, wherein said ridges and ribs are formed unitary and integral with said first and second sheets.

13. The package of claim 11, wherein said ridges are formed as a loop in said polymeric sheet.

14. The reclose mechanism of claim 11, wherein said ridges are formed as complementary ‘S-shaped’ folds in said polymeric sheets.

15. The package of claim 11 wherein said ribs extend less than 0.4 mm from the surface of said ridges.

16. The package of claim 15, wherein said ribs run substantially parallel with said ridges.

17. The package of claim 16, wherein said ribs are spaced on a pitch of between 0.03 mm and 0.7 mm.

18. The package of claim 17, wherein said ribs are spaced apart by 0.1 mm.

19. The package of claim 12, wherein said ridges are formed by an embossing process.

20. A method for manufacturing a reclose mechanism as defined in claim 1 or for manufacturing a package as defined in claim 11, said method including the steps of:
embossing opposing surfaces of first and second polymeric sheets, in at least an area adjacent an opening of a bag or sachet, in order to form ribs;
shaping said polymeric sheets, in the area so embossed, to form said ridges in said sheets;
wherein said ridges are formed substantially parallel with said ribs.

21. The method of claim 20, wherein said shaping of said ridges is achieved by a process selected from a group consisting of moulding-, folding, and pressing processes.

22. (canceled)

23. (canceled)

24. (canceled)

25. (canceled)
